(19) United States
(12) Patent Application Publication
(10) Pub. No.: US 2009/0268226 A1
(43) Pub. Date: Oct. 29, 2009

(54) IMAGE FORMING APPARATUS, CONTROL METHOD THEREOF, AND COMPUTER PROGRAM

(75) Inventor: Hiroyuki Horii, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/418,863

(22) Filed: Apr. 6, 2009

(30) Foreign Application Priority Data
Apr. 25, 2008 (JP) 2008-116292

(51) Int. Cl. G06K 15/00; G06F 3/12

(52) U.S. Cl. 358/1.14; 358/1.15

(57) ABSTRACT

An image forming apparatus that converts image data into print data to print is provided. The apparatus includes a conversion unit configured to generate first print data and second print data from the image data using an error diffusion method, and a printing unit configured to print the second print data. The conversion unit converts the image data into the first print data using the error diffusion method, generates constraint data specifying the non-print pixels in the first print data as non-print pixels in the second print data, and converts the image data into the plurality of pieces of second print data, each piece of second print data being used in one of the plurality of passes, through an error diffusion method that uses the constraint data. The printing unit forms an image by printing, in each of the plurality of passes, the second print data.

### BACKGROUND OF THE INVENTION

1. Field of the Invention

The present invention relates to an image forming technique, and particularly to an image forming technique based on multi-pass printing.

2. Description of the Related Art

In order to print using an image forming apparatus such as an inkjet printer, multi-valued image data that has been input is converted to binary print data or print data whose number of gradations has been reduced using a method such as an error diffusion method. Furthermore, in order to obscure unevenness in dots caused by the properties of the head, mechanical control errors, or the like, the region of print data that can be printed in a single scan is divided up into and printed across multiple passes. This printing method is called multi-pass printing. It is necessary to divide print data into multiple-pass print data in order to carry out multi-pass printing. Japanese Patent Laid-Open No. 05-031922 discloses a method in which different mask patterns are prepared in advance for each pass, and pass print data is calculated by obtaining the logical product of the mask pattern and the generated print data. In multi-pass printing, it is necessary for the result of printing the pieces of pass print data to correspond to the print data. For this reason, each mask pattern is generated so that arbitrary pixels are included within the mask pattern. In order to increase the dispersity of dots within the pass print data for each pass, the mask patterns are designed so that the position of dots therein is as random as possible.

The technique disclosed in Japanese Patent Laid-Open No. 05-031922 executes the pass division for multi-pass printing using mask patterns set in advance. It is necessary for the size of a single mask pattern to be the same as the number of pixels in the image that is to be printed. In other words, division into n passes requires n mask patterns. For this reason, the mask patterns strain the limited memory region available within the printer device.

In addition, the print data is created independently from the mask patterns that are set in advance. The mask patterns are designed so that the print data is allocated among the passes at random. As opposed to this, the print data is dependent on the input image, and is generated so that the generated dots are sparse in brighter portions and numerous in darker portions. Therefore, when taking the logical product of the print data dependent on the input and the mask patterns designed independent thereof and making the pass divisions, there are situations where interference between the print data and mask patterns prevents the ideal pass division from being made, leading to degradation in the image that is formed. The reason for this is that because the logical product of the print data dependent on the input and the mask patterns designed independently thereof is taken and the pass divisions are made, the dispersity of dots between passes cannot be guaranteed. For example, a problem sometimes occurs in which when the pass divisions are made, the number of printed dots is high in a certain pass while the number of printed dots is low in another pass. There are cases where the abovementioned phenomenon leads to degradation in the formed image when multi-pass printing using mask patterns is performed.

In this manner, it has been difficult, conventionally, to perform multi-pass printing while ensuring the independence and dispersity of dots among pieces of pass print data.

Accordingly, the present invention enables multi-pass printing while ensuring the independence and dispersity of dots among pieces of pass print data.

### SUMMARY OF THE INVENTION

According to one aspect of the present invention, an image forming apparatus that converts image data into print data that contains print pixels and non-print pixels, divides the print data into a plurality of passes, and prints the print data, is provided. The apparatus includes a conversion unit configured to generate first print data and a plurality of pieces of second print data by converting the image data using an error diffusion method; and a printing unit configured to print the plurality of pieces of second print data. The conversion unit performs a first conversion that converts the image data into the first print data using the error diffusion method, generates constraint data specifying the non-print pixels in the first print data as non-print pixels in the second print data, and performs a second conversion that converts the image data into the plurality of pieces of second print data, each piece of second print data being used in one of the plurality of passes, through an error diffusion method that uses the constraint data. The printing unit forms an image expressing the image data by printing, in each of the plurality of passes, the piece of second print data that corresponds to the pass.

Further features of the present invention will become apparent from the following description of exemplary embodiments (with reference to the attached drawings).

### BRIEF DESCRIPTION OF THE DRAWINGS

FIG. 1 is a block diagram illustrating an example of the hardware configuration of a printer 100 according to an embodiment of the present invention.

FIG. 2 is a diagram illustrating an example of input image data according to an embodiment of the present invention.

FIG. 3 is an example of print data 300 obtained as a result of binarizing input image data 200 through the error diffusion method, according to an embodiment of the present invention.

FIGS. 4A to 4C are diagrams illustrating an example of a diffusion rule for error that has occurred, according to an embodiment of the present invention.

FIG. 5 is a diagram illustrating an example of constraint data 500 and print data 510 based thereupon, according to an embodiment of the present invention.

FIG. 6 is a diagram illustrating an example of print data where a print duty has been set, according to first and second embodiments of the present invention.

FIG. 7 is a diagram illustrating an example of the progress of image formation when multi-pass printing is performed, according to an embodiment of the present invention.

FIG. 8 is a diagram illustrating an example of the progress of constraints given to each pass and the print data, according to an embodiment of the present invention.

FIG. 9 is an example of a block diagram illustrating the configuration of a binary conversion processing unit 900 according to the first embodiment of the present invention.

FIG. 10 is a flowchart illustrating an example of operations performed by the binary conversion processing unit 900 according to the first embodiment of the present invention.

FIG. 11 is a diagram illustrating an example of the configuration of a constraint buffer 920 according to the first embodiment of the present invention.

FIG. 12 is a diagram illustrating an example of the progress of the constraint buffer 920 when converting the input image data into binary form, according to the first embodiment of the present invention.

FIG. 13 is a diagram illustrating an example of the configuration of an error buffer 930 according to an embodiment of the present invention.

FIG. 14 is a diagram illustrating an example of the progress of the error buffer 930 when converting the input image data into binary form, according to an embodiment of the present invention.

FIG. 15 is an example of a flowchart illustrating multi-pass printing of input image data according to an embodiment of the present invention.

FIG. 16 is a diagram illustrating an example of the progress of the constraints given to each pass and the print data, according to the second embodiment of the present invention.

FIG. 17 is a block diagram illustrating an example of the configuration of a binary conversion processing unit 106 according to the second embodiment of the present invention.

FIG. 18 is a flowchart illustrating an example of operations performed by the binary conversion processing unit 106 according to the second embodiment of the present invention.

FIG. 19 is a block diagram illustrating an example of the configuration of a binary conversion processing unit 1900 according to a third embodiment of the present invention.

### DESCRIPTION OF THE EMBODIMENTS

Hereinafter, embodiments of the present invention shall be described in detail with reference to the appended drawings. In the following embodiments, a printer shall be discussed as an example of the image forming apparatus. In the present specification, “image” refers to an item printed by the printer onto a printing medium such as recording paper, and also includes documents and the like made up solely of text and symbols. Furthermore, “print” refers to forming an image by discharging ink or the like, and is not limited only to the printing of text.

### First Embodiment

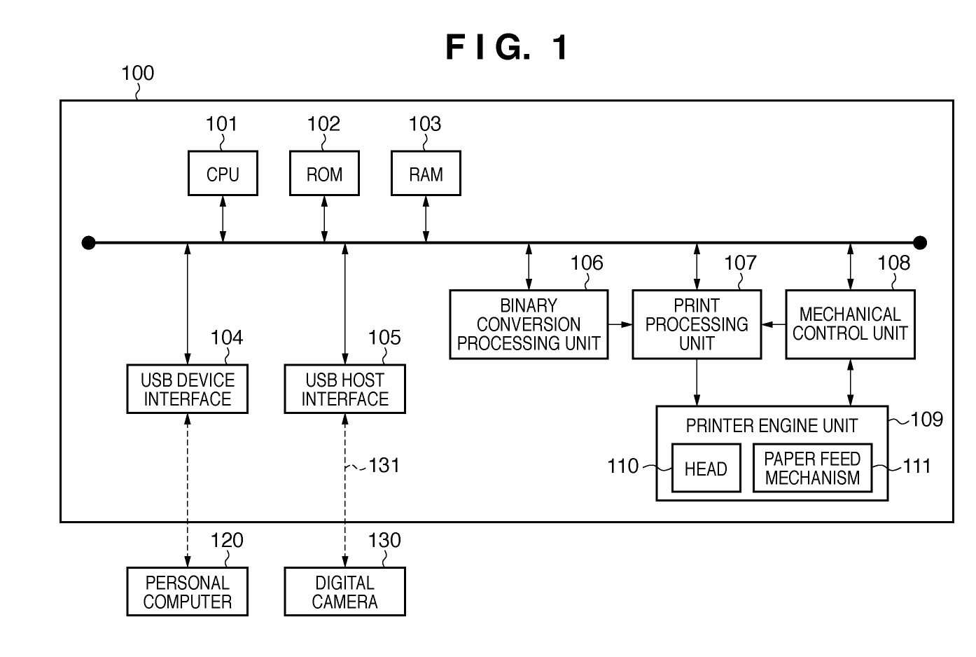

The hardware configuration of a printer according to the present invention shall be described using FIG. 1. FIG. 1 is a block diagram illustrating an example of the hardware configuration of a printer 100.

The printer 100 includes a CPU 101, a ROM 102, a RAM 103, a binary conversion processing unit 106, a print processing unit 107, a mechanical control unit 108, and a printer engine unit 109.

The CPU 101 performs overall control of the printer 100. The ROM 102 stores programs executed by the CPU 101, data tables, and so on. The RAM 103 stores variables and data, as well as an error buffer, a constraint buffer, and the like, which shall be mentioned later.

The binary conversion processing unit 106 converts multi-valued input image data input to the printer 100 into binary print data, which is a printable format. The print processing unit 107 outputs the print data to the printer engine unit 109, thereby printing the print data. The mechanical control unit 108 controls the printer engine unit 109 so as to perform the print. The printer engine unit 109 includes a head 110 having multiple nozzles that discharge ink, a paper feed mechanism 111, a carriage feed mechanism (not shown), and so on. The head 110 discharges ink based on the print data input by the print processing unit 107, thereby printing the input image data.

The printer 100 further includes a USB device interface 104 and a USB host interface 105. The USB device interface 104 accepts image data from a personal computer 120. The USB host interface 105 accepts image data from a digital camera 130 or the like.

An example in which an image captured by the digital camera 130 is sent directly to the printer 100 and printed shall be described next. The image captured by the digital camera 130 is stored, as compressed JPEG data, in a memory (not shown) within the digital camera 130. The digital camera 130 is then connected to the USB host interface 105 of the printer 100 using a connection cable 131. The JPEG data stored in the memory of the digital camera 130 is temporarily stored in the RAM 103 of the printer 100 via the USB host interface 105. The CPU 101 decompresses the JPEG data obtained from the digital camera 130 and stores the resulting input image data in the RAM 103 once again.

The input image data stored in the RAM 103 is then converted by the binary conversion processing unit 106 into a printable format, or in other words, print data, after which multiple pieces of partial print data are created in order to perform multi-pass printing. Pass division processing shall be described in detail later. The partial print data is sent to the head 110 by the print processing unit 107, in accordance with the driving order of the head. An image is then formed upon print media by the mechanical control unit 108 and the printer engine unit 109 controlled thereby synchronizing with each other and discharging ink droplets.

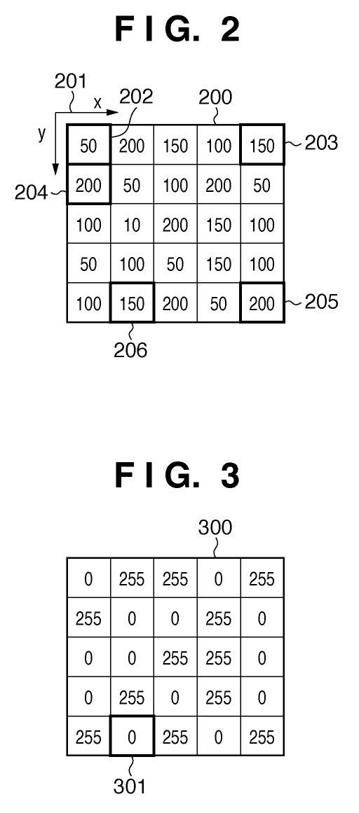

Next, the error diffusion method shall be described using FIGS. 2 to 6.

The error diffusion method is a technique for reducing the information amount by converting the image data. In the present embodiment, this technique binarizes the pixel value of each pixel in the image data. It is assumed here that the image data indicated in FIG. 2 has been provided as input image data 200. FIG. 2 is a diagram illustrating an example of the input image data. A pixel value corresponding to the density of the pixel is given to each pixel in the input image data 200. A higher numerical value indicates a denser pixel. In the present embodiment, the pixel value of each pixel is assumed to have an information amount of 8 bits, and thus the value that each pixel can take on is an integer value ranging from 0 to 255. Furthermore, in order to facilitate the descriptions, an xy coordinate system 201 has been set. It is assumed that the image data discussed hereinafter has also had a similar coordinate system set.

FIG. 3 is an example of print data 300 obtained as a result of binarizing input image data 200 through the error diffusion method. It is assumed that the pixel value of each pixel in the print data 300 is either 0 or 255. Hereinafter, converting the input image data to print data using the error diffusion method is also sometimes referred to as “error diffusion of input image data”.

The error diffusion method is a method that minimizes error in the overall image data by reflecting error due to the binary conversion of each pixel in the pixel values of the surrounding pixels. In the error diffusion method, binary conversion processing is performed sequentially for each pixel. For example, with the input image data 200 shown in FIG. 2, the binary conversion process is commenced from a pixel 202 located on the upper-left, and each pixel is then processed in order progressing along the x axis. When the binary conversion process has ended for a pixel 203 located on the right side of the input image data 200, the process is continued from a pixel 204, located on the left end of the following row in the y axis direction. The input image data 200 is thus binarized by repeating this binary conversion process until a pixel 205, on the bottom-right of the input image data 200, has been converted. Through this process, the pixels are classified into print pixels, for which dots are discharged, and non-print pixels, for which dots are not discharged.

The binary conversion process is performed for each pixel (x, y) through the following equations (1) through (3).

B(x,y)=255(if I′(x,y)≧T), (1)

B(x,y)=0(if I′(x,y)<T), (2)

(where, I′(x,y)=I(x,y)+Err(x,y).) (3)

Here, I(x, y) and B(x, y) are pixel values of the pixels (x, y) of the input image data 200 and the print data 300, respectively. Meanwhile, T is a predetermined threshold, and is, for example 128 in the case where the pixel values can take on a value in the range of 0 to 255. Err(x, y) is the accumulated error of the pixel (x, y). I′ (x, y) is the pixel value of the pixel (x, y) in the input image data 200 in which the accumulated error is reflected.

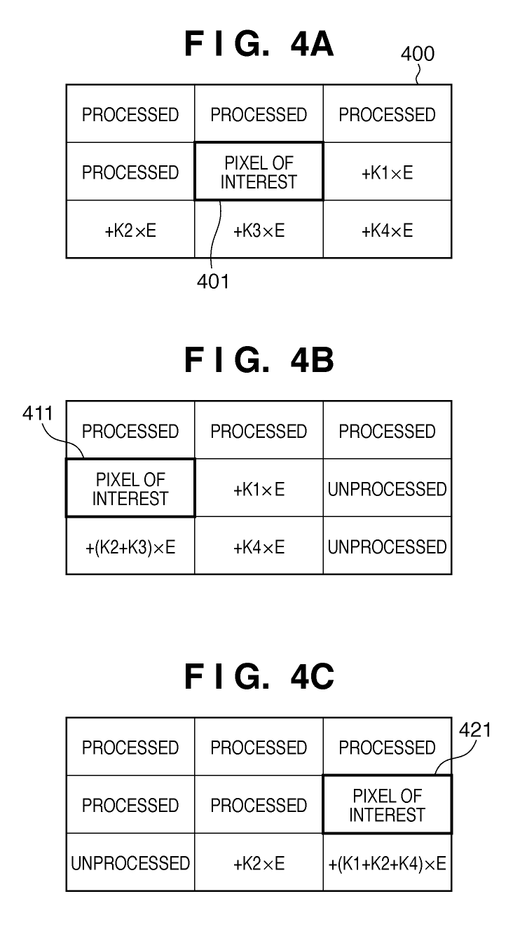

FIGS. 4A to 4C are diagrams illustrating an example of a diffusion rule for error that has occurred. Image data 400 in FIG. 4A represents a part of interest of the input image data 200. I′ (x, y), which is the pixel value of the input image data 200 in which the accumulated error is reflected, is converted to a binary pixel value B (x, y) through the binary conversion process. Therefore, an error represented by I′ (x, y)−B(x, y) (or =E) occurs in a pixel of interest (x, y) 401. This error E is diffused among the peripheral pixels that have not yet undergone the binary conversion process. To be more specific, processing according to the following equations (4) through (7) is performed.

Err(x+1,y)=Err(x+1,y)+K1*E (4)

Err(x−1,y+1)=Err(x−1,y+1)+K2*E (5)

Err(x,y+1)=Err(x,y+1)+K3*E (6)

Err(x+1,y+1)=Err(x+1,y+1)+K4*E (7)

Where, K1 to K4 are predetermined constants. In an example, these are defined so that the total value is 1, and thus, for example, K1= 7/16, K2= 3/16, K3= 5/16, and K4= 1/16.

In the case where the binary data B(x, y) is less than the corrected pixel value I′ (x, y), in which the accumulated error is reflected, the value of E is positive, and thus the pixel values of the peripheral pixels, in which the accumulated error is reflected, increase. Accordingly, in the case where a pixel whose pixel value has increased undergoes binary conversion, it is more likely to exceed the threshold than when the pixel value I(x, y) of the input image data is compared to the threshold as-is. The same can be said for when the value of E is negative. Therefore, when the entirety of the image data is considered, it is possible to create print data that obtains a more natural print result than in the case where the pixel values are simply compared to the threshold and binarized.

For example, the pixel value of a pixel 206 shown in FIG. 2 is 150, and thus exceeds the threshold of 128. However, as a result of reflecting the error that has occurred in the peripheral pixels, the pixel value of the corresponding pixel 301 in the print data 300 shown in FIG. 3 is 0. In the present embodiment, error occurring in the pixel of interest is diffused among the four peripheral pixels, but it is also possible to diffuse the error to a greater number of pixels.

Note that in the case where a pixel of interest (x, y) 411 is located at the left side of the input image data 200, as shown in FIG. 4B, processing according to the following equations (8) to (10) is performed.

I(x+1,y)=I(x+1,y)+K1*E (8)

I(x,y+1)=I(x,y+1)+(K2+K3)*E (9)

I(x+1,y+1)=I(x+1,y+1)+K4*E (10)

Meanwhile, in the case where a pixel of interest (x, y) 421 is located at the right side of the input image data 200, as shown in FIG. 4C, processing according to the following equations (11) and (12) is performed.

I(x−1,y+1)=I(x−1,y+1)+K2*E (11)

I(x,y+1)=I(x,y+1)+(K1+K3+K4)*E (12)

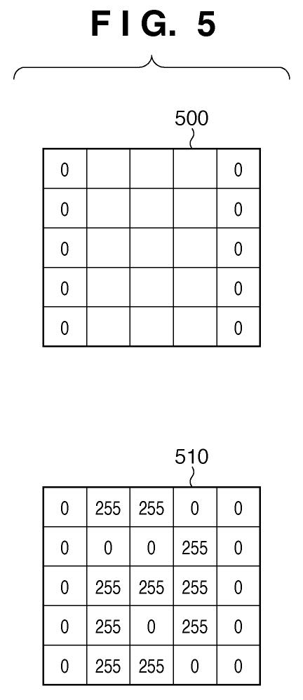

Next, an error diffusion method for the case where a constraint is provided shall be described using FIG. 5. FIG. 5 is a diagram illustrating an example of constraint data 500 and print data 510 based thereupon.

“Constraint” refers to post-conversion pixel values specified in advance in the binary conversion process. For example, a constraint on the input image data 200 is provided as a two-dimensional array, as indicated by the constraint data 500 shown in the upper section of FIG. 5. The elements of the constraint data 500 correspond to the pixels in the input image data. In the constraint data 500, 0 is specified as the post-conversion pixel values for all the pixels located on both sides of the input image data. For this reason, with print data resulting from error conversion performed using this constraint, it is necessary for all the pixel values of the pixels located on both sides to be 0. When, for example, error diffusion is performed on the input image data 200 shown in FIG. 2 using the constraint data 500, the print data 510 shown in the lower section of FIG. 5 is obtained. Pixels whose pixel values have not been specified in the constraint data 500 can take on values of either 0 or 255 in the print data 510.

Next, processing performed in the error diffusion method when a constraint has been applied shall be described. The pixels whose pixel values have been specified in the constraint data 500 do not undergo the processing indicated by the equations (1) to (3); rather, the specified pixel values are taken as-is as pixel values B(x, y) of the print data 510. Pixels that have not been constrained undergo the binary conversion processing indicated by the equations (1) to (3) in the same manner as the error diffusion method in which a constraint is not applied. With regards to error diffusion, the processing indicated by the equations (4) through (12) is performed regardless of whether or not a constraint is present. As a result, the print data 510 indicated in the lower section of FIG. 5 is obtained. The result is different from the print data 300 shown in FIG. 3, in which no constraint was applied.

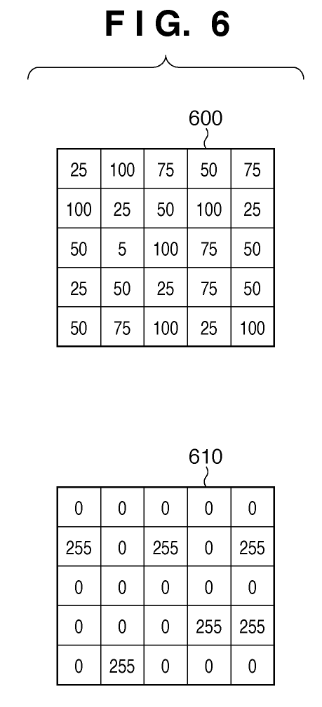

Furthermore, an error diffusion method used in the case where a print duty has been set shall be described next using FIG. 6. FIG. 6 is a diagram illustrating an example of print data where a print duty has been set. “Print duty” refers to the printing rate, and specifies the percentage of dots numbers discharged by the head 110. For example, print data for when the print duty is set to 50% has a discharged dot number that is 50% that of print data for when the print duty is not set or is set to 100%.

In order to perform a binary conversion process in which a print duty has been set, error diffusion can be performed on image data 600, whose pixel values are values in which the pixel values of the pixels in the input image data 200 have been multiplied by the print duty. Through this, the data is converted into the print data 610 shown in the lower section of FIG. 6. The number of dots discharged in the printing of the print data 610, or in other words, the number of pixels whose pixel values are 255, becomes approximately 50% of the number of dots used in printing the print data 300 shown in FIG. 3. With the error diffusion method, error occurring during the binary conversion process is diffused between the peripheral pixels, and therefore the total of the pixel values in the pre-conversion input image data 200 is essentially equivalent to the total of the pixel values in the post-conversion print data 300. Therefore, if error diffusion is performed on the image data resulting from multiplying the pixel values of the pixels in the input image data 200 by the print duty, the data can be converted into print data that fulfills the desired print duty. Note that it is possible to set the threshold T in the equations (1) and (2) in accordance with the range of pixel values in the image data obtained after multiplication with the print duty. For example, in the case where the print duty is 50%, the range of values that the pixels can take on is from 0 to 127, and thus the threshold T is set to 64. The above has been a description of the error diffusion method.

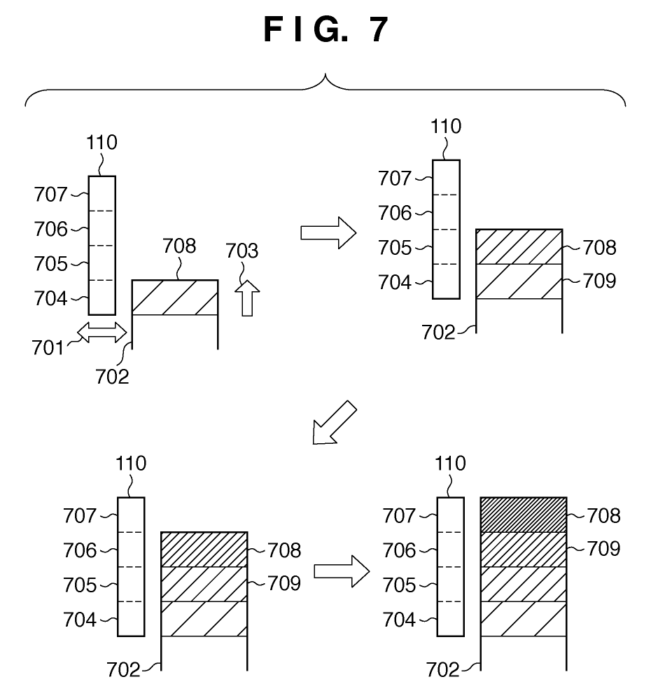

Next, multi-pass printing shall be described using FIG. 7. FIG. 7 is a diagram illustrating an example of the progress of image formation when multi-pass printing is performed. “Multi-pass printing” is a technique that divides a print medium 702, such as paper, into multiple print regions, and prints by making multiple scans in each print region, the scans being performed by the head 110. The “scan” performed by the head 110 refers to the head 110 moving above the print medium 702 while discharging ink. Furthermore, a scan within a single print region is called a “pass”. The present embodiment describes an example of four-pass printing, where printing is performed by making four scans within a single print region; however, the number of passes is not limited to four.

The head 110, which has multiple nozzles, performs a scan in the direction of an arrow 701, and each nozzle discharges ink onto the print medium 702 based on the print data that is to be printed. When the scan finishes, the paper feed mechanism 111 advances the print medium 702 in the direction of an arrow 703 by a predetermined length.

In n-pass printing, where the printing is divided into n passes, the nozzles included in the head 110 are generally divided into n groups, and the paper is advanced by 1/n the width of the head 110 with each scan. Through this, a total of n scans are performed in each print region of the print medium 702. In addition, although n-pass printing can be performed by advancing the paper by the width of the head 110 each time n scans have been made, this shall not be discussed in the present embodiment.

In the present embodiment, because the printing is four-pass printing, the nozzles included in the head 110 are divided into four groups, or nozzle groups A704 to D707. Each nozzle group includes the same number of nozzles. For example, if the head 110 includes 512 nozzles, each nozzle group includes 128 nozzles. As shown in the upper-left of FIG. 7, in the first scan, the first pass of printing is made by the nozzle group A704 in a first print region 708 on the print medium 702, after which the paper is advanced.

Then, as shown in the upper-right of FIG. 7, in the second scan, the second pass of printing is made by the nozzle group B705 in the first print region 708, and the first pass of printing is made by the nozzle group A704 in a second print region 709.

Next, as shown in the lower-left of FIG. 7, in the third scan, the third pass of printing is made by the nozzle group C706 in the first print region 708, and the second pass of printing is made by the nozzle group B705 in the second print region 709. Note that descriptions of the third and subsequent print regions of the print medium 702 have been omitted for the sake of simplicity. However, the same processing as described above is performed thereon.

Next, as shown in the lower-right of FIG. 7, in the fourth scan, the fourth pass of printing is made by the nozzle group D707 in the first print region 708, and the second pass of printing is made by the nozzle group C706 in the second print region 709. Through the above process, printing onto the first print region 708 of the print medium 702 is completed upon the fourth scan. Printing onto the print medium 702 is completed by repeating this process.

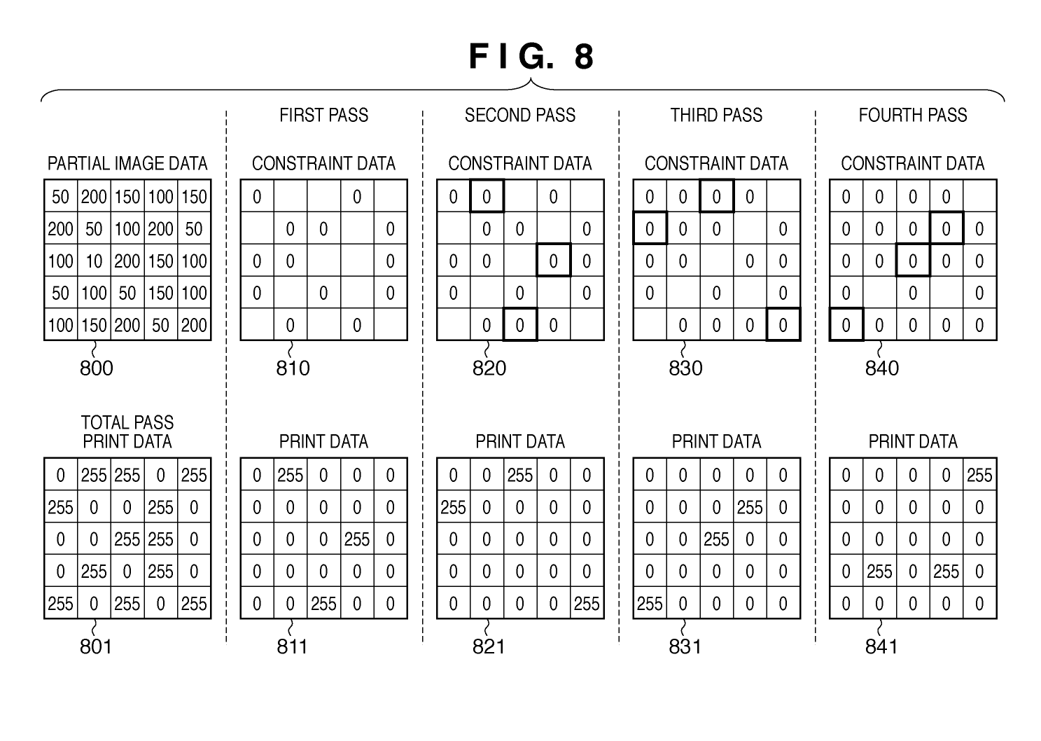

When performing multi-pass printing, it is necessary to determine in which pass ink is to be discharged for each pixel. In the present invention, this is determined through the error diffusion method. An outline of the method for making pass divisions using the error diffusion method shall be described using FIG. 8. FIG. 8 is a diagram illustrating an example of the progress of the constraints given to each pass and the print data.

First, the input image data is divided into partial image data based on the number of pixels that can be printed by a single nozzle group in a single scan. For example, in the case where a nozzle group includes 128 nozzles, the image data is divided into partial image data that contains 128 pixels in the y-axis direction and a number of pixels equivalent to the printing width of the printer 100 in the x-axis direction. A partial image data 800 shown in FIG. 8 shall be used as an example. The partial image data 800 is printed, for example, in the first print region 708 shown in FIG. 7.

During the processing of the first pass made for the partial image data 800, error diffusion is performed with no constraint on the partial image data 800, converting that data into partial print data. This partial print data is called total pass print data 801. In the total pass print data 801, which is first print data obtained through a first conversion, pixels with a pixel value of 255 are pixels for which dots are ultimately discharged. At this stage, in which of the four scans that are to be carried out dots will be discharged is not set, but it is certain that dots will be discharged in one of the scans. On the other hand, it is certain that no dots will be discharged for pixels in the total pass print data 801 with a pixel value of 0.

Furthermore, during the processing of the first pass, which is the preciding pass, first pass constraint data 810 is determined based on the total pass print data 801, and the partial image data 800 is converted into first pass print data 811 through error diffusion that utilizes this constraint. Through this second conversion, print data for each pass, or second print data, is obtained. The print duty is set to 25% in this error diffusion. The first pass print data 811 is printed during the scan of the first pass. Furthermore, the first pass print data is also used as a constraint for the error diffusion in the subsequent passes.

In multi-pass printing, it is possible for the number of dots discharged to be approximately the same in each pass. Accordingly, when performing four-pass printing, a binary conversion process is performed using a print duty of 25%, and the print data obtained as a result thereof is printed. In addition, pixels in the total pass print data 801 with a pixel value of 0 should also have a pixel value of 0 in the first pass print data 811. Accordingly, pixels in the total pass print data 801 with a pixel value of 0 are specified to have a constraint value of 0 in the first pass constraint data 810. Pixels in the total pass print data 801 with a pixel value of 255 may also have a pixel value of 255 in the first pass print data 811 or in the print data of subsequent passes, and thus a constraint is not specified therefor.

Next, during the processing of the second pass, second pass constraint data 820 is determined based on the total pass print data 801 and the first pass print data 811; the partial image data 800 is converted into second pass print data 821 through error diffusion provided with this constraint. The print duty is set to 25% in this error diffusion as well. The second pass print data 821 is printed during the scan of the second pass.

The duty is set to 25% for the same reasons as described earlier. In addition, pixels in the total pass print data 801 with a pixel value of 0 should also have a pixel value of 0 in the second pass print data 821. Furthermore, pixels printed in the first pass, or in other words, pixels in the first pass print data 811 with a pixel value of 255, do not need to be printed in the second pass. Accordingly, a constraint that applies a constraint value of 0 to pixels in the first pass print data 811 with a pixel value of 255 is added to the first pass constraint data 810. Second pass constraint data 820 is obtained as a result. Elements enclosed in a bolded frame are elements to which a constraint has been newly added by the second pass constraint data 820.

Similarly, during the processing of the third pass, third pass constraint data 830 is determined based on the total pass print data 801, the first pass print data 811, and the second pass print data 821. As a result of error diffusion, the partial image data 800 is converted into third pass print data 831, which is then printed.

During the processing of the fourth pass, which is the final pass, the pixels in the total pass print data 801 that have not been printed by the time the third pass has been performed are printed without performing error diffusion. As described earlier, elements for which a constraint is not specified in fourth pass constraint data 840 that has been created are pixels for which dots should be discharged but for which dots have not been discharged in any of the passes thus far. Accordingly, fourth pass print data 841, which specifies the pixel value of pixels for which a constraint is not specified as 255, is created, and that data is then printed.

The partial image data 800 is divided into four passes and printed through the process described above.

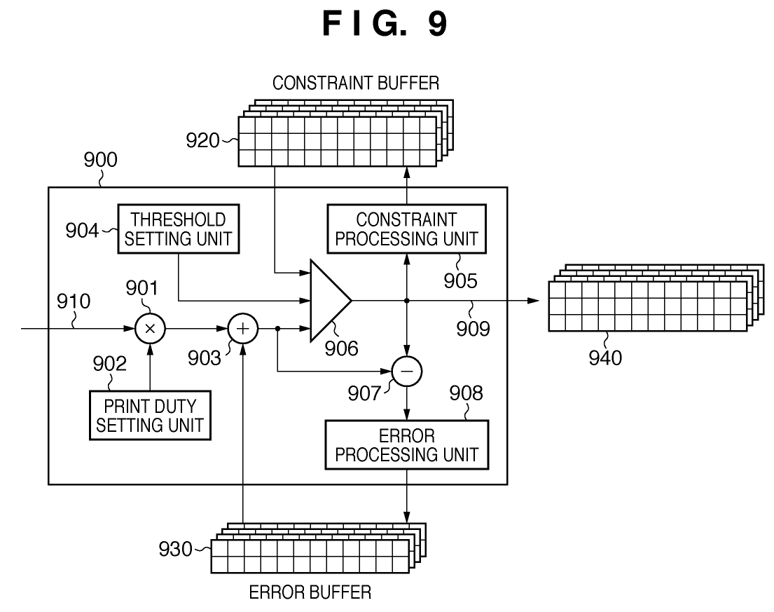

Next, details of multi-pass printing shall be described with reference to FIGS. 9 through 15.

FIG. 9 is an example of a block diagram illustrating the configuration of a binary conversion processing unit 900. The binary conversion processing unit 900 corresponds to the binary conversion processing unit 106 shown in FIG. 1. The binary conversion processing unit 900 sequentially reads out, from the RAM 103, pixel values 910 of the partial image data obtained based on the input image data. A print duty setting unit 902 sets a print duty used in error diffusion. A multiplier 901 multiplies the pixel values 910 of the input image data by the print duty set by the print duty setting unit 902. An adder 903 adds the output of the multiplier 901 to the accumulated error of a pixel of interest loaded from an error buffer 930. A threshold setting unit 904 sets the threshold T used in error diffusion. A binary data output unit 906 calculates pixel values 909 for print data from the pixel values input from the adder 903, the threshold T input from the threshold setting unit 904, and the constraint value of the pixel of interest loaded from a constraint buffer 920, and outputs the resultant. A constraint processing unit 905 updates constraint data stored in the constraint buffer 920 based on the pixel values 909 of the print data. A subtractor 907 finds the difference between the output from the binary data output unit 906 and the output from the adder 903, and outputs the resultant to an error processing unit 908. The error processing unit 908 diffuses error arising in the pixel of interest to other pixels, and updates the error buffer 930 based on the results of that diffusion.

The constraint buffer 920 stores constraint data used in error diffusion, and is located in the RAM 103. The error buffer 930 stores the accumulated error of each pixel, and is located in the RAM 103 as well. A print buffer 940 stores the pixel values 909 of the print data, and is located in the RAM 103.

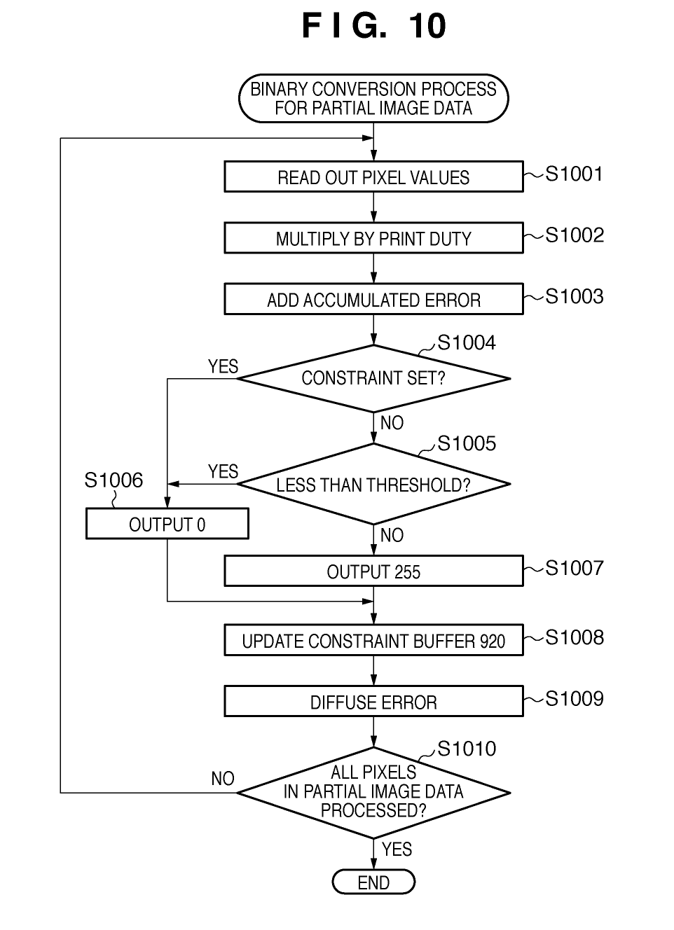

Next, operations performed by the binary conversion processing unit 900 shall be described using FIG. 10. FIG. 10 is a flowchart illustrating an example of operations performed by the binary conversion processing unit 900. Processing based on this flowchart is performed by the CPU 101 executing a computer program loaded in the ROM 102. This execution may be partially carried out by hardware.

In step S1001, the binary conversion processing unit 900 reads out the pixel values 910 of the partial image data.

In step S1002, the multiplier 901 multiplies the print duty set by the print duty setting unit by the pixel values 910 of the partial image data, and outputs the resultant to the adder 903. The print duty setting unit 902 sets the print duty to 100% in the case where the input image data is converted to total pass print data, and sets the print duty to 25% in the case where the input image data is converted to partial print data for each pass.

In step S1003, the adder 903 adds the accumulated error of the pixel of interest read out from the error buffer 930 to the input from the multiplier 901, and outputs the resultant to the binary data output unit 906.

In step S1004, the binary data output unit 906 refers to the constraint buffer 920, and determines whether or not a constraint value is specified for the pixel of interest. In the case where the value in the constraint buffer 920 for the pixel of interest is 0, the binary data output unit 906 specifies a constraint value of 0, whereas in the case where the value in the constraint buffer 920 for the pixel of interest is 1, no constraint value is specified. Note that it is assumed that all elements in the constraint buffer 920 are initialized to 1 prior to carrying out error diffusion.

In the case where a constraint is specified (“YES” in step S1004), the process moves to step S1006, where the binary data output unit 906 outputs 0 in accordance with the constraint.

However, in the case where a constraint is not specified (“NO” in step S1004), the process moves to step S1005.

In step S1005, the binary data output unit 906 compares the value of the input from the adder 903 with the threshold set by the threshold setting unit 904. The threshold setting unit 904 sets the threshold based on the print duty. For example, in the case where the print duty is 100%, the threshold is set to 128, whereas in the case where the print duty is 25%, the threshold is set to 32.

In the case where the input from the adder 903 is the lesser of the two (“YES” in step S1005), the process moves to step S1006. In step S1006, the binary data output unit 906 outputs 0.

However, in the case where the input from the adder 903 is not the lesser of the two (“NO” in step S1005), the process moves to step S1007. In step S1007, the binary data output unit 906 outputs 255.

In step S1008, the constraint processing unit 905 updates the constraint buffer 920. When performing error diffusion that converts the input image data to total pass print data, the constraint processing unit 905 changes the constraint values of pixels for which 0 was outputted to 0. Meanwhile, when performing error diffusion that converts the input image data to print data for each pass, the constraint processing unit 905 changes the constraint values of pixels for which 255 was outputted to 0.

In step S1009, the subtractor 907 calculates the error arising in the pixel of interest, and inputs the resultant to the error processing unit 908. Based on the input error, the error processing unit 908 updates the accumulated error in the peripheral pixels of the pixel of interest based on the equations (4) to (12).

In step S1010, the binary conversion processing unit 900 determines whether or not the binary conversion process has been completed for all pixels in the partial image data. In the case where the process has not been completed (“NO” in step S1010), the process returns to step S1001, and the next pixel is processed. However, in the case where the process has been completed (“YES” in step S1010), the binary conversion process of the partial image data ends.

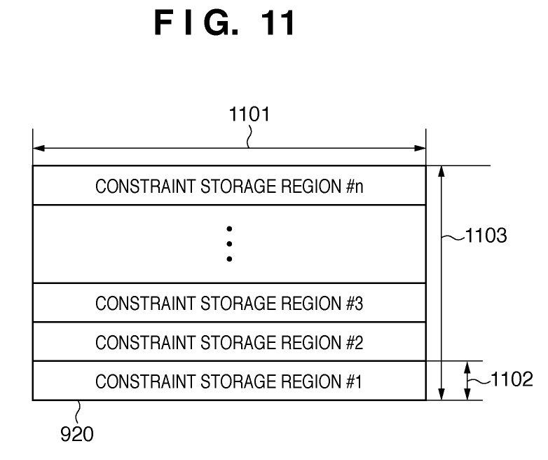

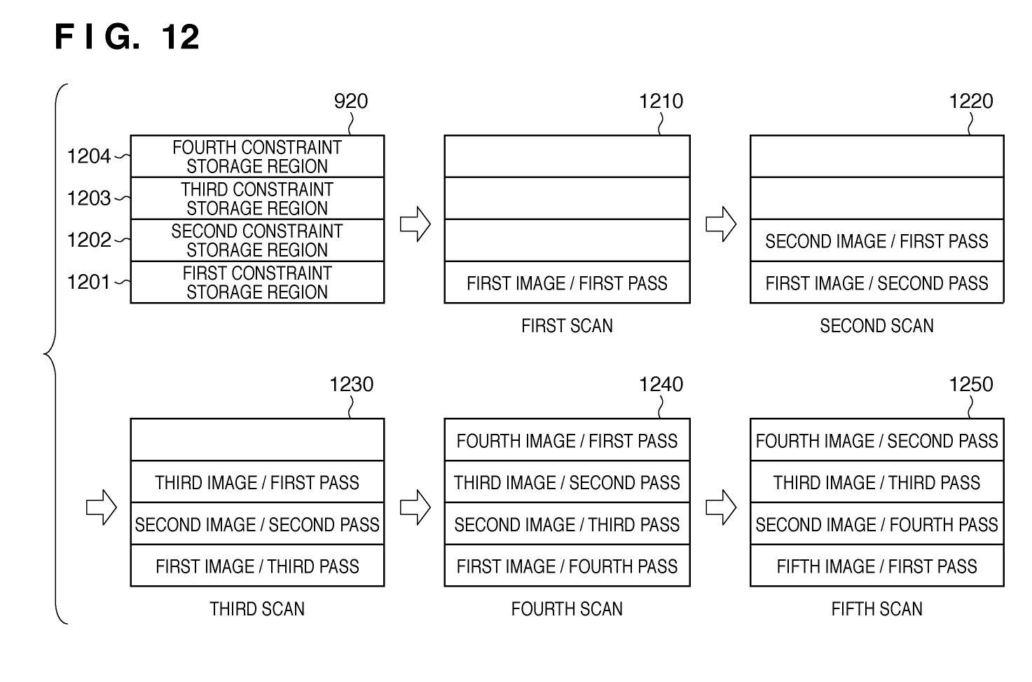

Continuing on, the constraint buffer 920 shall be described in detail using FIGS. 11 and 12.

FIG. 11 is a diagram illustrating an example of the configuration of the constraint buffer 920. In each constraint storage region, which stores the constraint data used in a single error diffusion, the number of elements in the x-axis 1101 is equal to the print width of the printer 100, and the number of elements in the y-axis 1102 is equal to the number of nozzles included in a single nozzle group. In n-pass printing, there is at most a number n error diffusions performed at the same time, and thus it is sufficient for the constraint buffer 920 to store n pieces of constraint data. Here, in n-pass printing, the head 110 is divided into n nozzle groups, and thus the number of elements in the y-axis 1103 for the constraint buffer 920 is equal to the number of nozzles included in the head. In other words, it is necessary for the constraint buffer 920 to have regions sufficient for the number of nozzles in the head×the print width of the printer 100. Each region holds 1 bit's worth of information.

FIG. 12 is a diagram illustrating an example of the progress of the constraint buffer 920 when converting the input image data into binary form. In the present embodiment, four-pass printing shall be used as an example. The constraint buffer 920 is divided into four constraint storage regions, from a first constraint storage region 1201 to a fourth constraint storage region 1204.

In the first scan, error diffusion without constraint, and the error diffusion for the first pass, are performed on the first partial image data. The constraint data necessary for these error diffusions is stored in the first constraint storage region 1201. The first pass constraint data 810 shown in FIG. 8, for example, is stored in the first constraint storage region 1201. The result of the abovementioned process is that the state of the constraint buffer 920 becomes as indicated by a constraint buffer 1210.

In the second scan, the error diffusion for the second pass is performed on the first partial image data. The constraint data necessary for this error diffusion is the constraint data stored in the first constraint storage region 1201, but which has been updated. The second pass constraint data 820 shown in FIG. 8, for example, is stored in the first constraint storage region 1201. In addition, error diffusion without constraint, and the error diffusion for the first pass, are performed on the second partial image data. The constraint data necessary for these error diffusions is stored in the second constraint storage region 1202. The result of the abovementioned process is that the state of the constraint buffer 920 becomes as indicated by a constraint buffer 1220.

A similar process is performed in the third and fourth scans, and the state of the constraint buffer 920 following the completion of the scans becomes as indicated by constraint buffers 1230 and 1240, respectively.

Because the printing of the first partial image data is completed by the fourth scan, constraint data regarding the first partial image data stored in the first constraint storage region 1201 is not necessary. Accordingly, in the fifth scan, the constraint data necessary for the error diffusion for the first pass on the fifth partial image data is stored in the first constraint storage region 1201.

As described thus far, the constraint data necessary for the error diffusions is stored, using the constraint buffer 920 as a ring buffer. Note that by performing the process of the fourth pass on the first partial image data prior to the process of the first pass on the fourth partial image data in the fourth scan, the constraint necessary for the fourth partial image data can be stored in the first constraint storage region 1201. Through this, it is possible to reduce the amount of regions necessary in the constraint buffer 920 by one constraint storage region.

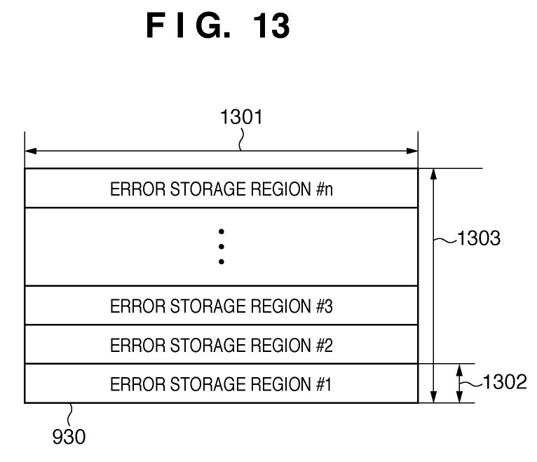

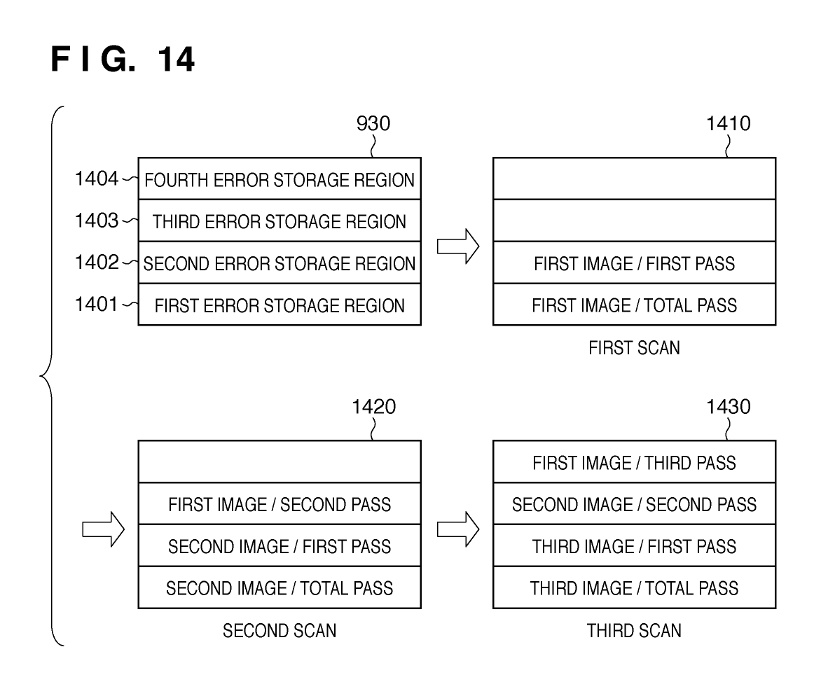

Continuing on, the error buffer 930 shall be described in detail using FIGS. 13 and 14.

FIG. 13 is a diagram illustrating an example of the configuration of the error buffer 930. In n-pass printing, a total of n error diffusions, for calculating the first pass print data to the n-1th pass print data and the total pass print data, are processed in each scan. As described earlier, error diffusion is not used when converting to the nth pass print data. As described with reference to FIGS. 4A to 4C, the error diffusion according to the present embodiment diffuses the error within the row that includes a pixel of interest and the next row. For this reason, the error storage region in the error buffer 930 necessary for a single error diffusion has a number of elements in the x-axis 1301 equal to the printing width of the printer 100, and a number of elements in the y-axis 1302 of 2. Therefore, the number of elements in the y-axis 1303 of the error buffer 930 is 2n. Based on this, (printing width of the printer 100)×2n regions are necessary in the error buffer 930 for n-pass printing. A bit number that conforms to the values that the accumulated error can take on is necessary in a single region. Note that the necessary regions fluctuate depending on the range of peripheral pixels to which the error is diffused.

FIG. 14 is a diagram illustrating an example of the progress of the error buffer 930 when converting the input image data into binary form. In the present embodiment, four-pass printing shall be used as an example. The error buffer 930 is divided into four error storage regions, from a first error storage region 1401 to a fourth error storage region 1404.

In the first scan, error diffusion is performed to convert the first partial image data into total pass print data and first pass print data. While the partial image data is common in this error diffusion, the constraints and print duties differ, and thus separate error storage regions are necessary. Accordingly, the error processing unit 908 stores the respective errors in the first error storage region 1401 and the second error storage region 1402.

In the second scan, error diffusion is performed to convert the first partial image data into second pass print data, and another error diffusion is performed to convert the second partial image data into total pass print data and first pass print data. Here, the error diffusion for converting the second partial image data into total pass print data is performed using the same conditions as the error diffusion for converting the first partial image data into total pass print data carried out in the first scan. Therefore, the error data used in the conversion to total pass print data in the first scan is once again used in the error diffusion for converting the second partial image data into total pass print data. Doing so makes it possible to binarize the pixels included in the first row of the second partial image data, applying the error occurring in the processing of the pixels therebefore. The same relationship holds true between the error diffusion of the first pass for the first partial image data and the error diffusion of the second pass for the second partial image data. The error of the second pass for the first partial image data is stored in the third error storage region 1403. The error buffer 930 is used in the same manner in the subsequent scans as well. As described earlier, in four-pass printing, four error storage regions are sufficient, as indicated by the error buffer 1430.

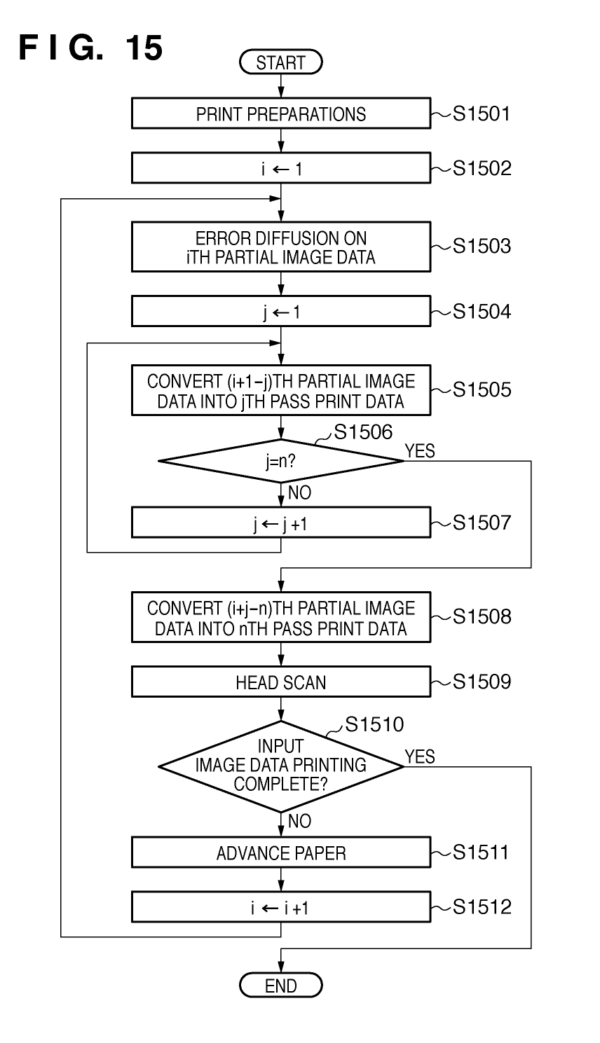

Finally, multi-pass printing of input image data shall be described using FIG. 15. FIG. 15 is an example of a flowchart illustrating multi-pass printing of input image data. Processing based on this flowchart is performed by the CPU 101 executing a computer program loaded in the ROM 102. This execution may be partially carried out by hardware.

In step S1501, the printer 100 prepares for printing. For example, input image data is read out from the digital camera 130 or the like, and written into the RAM 130. The paper feed mechanism 111 also advances the print medium to a predetermined position. Note that the input image data may be written into the RAM 103 all at once, or written into the RAM 103 per piece of partial image data to be printed.

In step S1502, the printer 100 initializes a variable i to 1. The variable i indicates which number scan out of the total number of scans is being processed.

In step S1503, the printer 100 performs error diffusion on the ith partial image data, converting it into total pass print data. The post-conversion print data corresponds to, for example, the total pass print data 801 shown in FIG. 8. The conversion into total pass print data follows the processing of the flowchart shown in FIG. 10. No constraints are specified in this process, and the print duty is set to 100%.

In step S1504, the printer 100 initializes a variable j to 1. The variable j indicates what number binary conversion process is performed on the partial image data in a single scan.

In step S1505, the printer 100 converts the (i+1−j)th partial image data into jth pass print data. For example, assume that i=3 and j=1. In this case, the printer 100 performs a first binary conversion on the partial image data in the third scan. Here, the printer 100 converts the third partial image data into first pass print data. The conversion into the jth pass print data follows the processing of the flowchart shown in FIG. 10. In this processing, the printer 100 uses the constraint data stored in the constraint buffer 920, with the print duty set to 25%. The printer 100 stores the data that has undergone the binary conversion in the print buffer 940.

In step S1506, the printer 100 determines whether or not j and n match. Here, n is the number of passes, and thus in four-pass printing, n=4.

In the case where j ≠n in step S1506 (“NO” in step S1506), the printer 100 increments the value of j by 1 in step S1507, after which the process returns to step S1505. In step S1507, for example, i=3 and j=2, and thus the printer 100 converts the second partial image data into second pass print data. The printer 100 stores the data that has undergone the binary conversion in the print buffer 940.

Meanwhile, in the case where j=n in step S1506 (“YES” in step S1506), the printer 100 converts the (i+1−n)th partial image data to nth pass print data in step S1508. This binary conversion is calculated, as described earlier, based on the constraint data stored in the constraint buffer 920, without using error diffusion.

In step S1509, the printer engine unit 109 causes the head 110 to scan and print onto the print medium based on the print data recorded in the print buffer 940. In the case of four-pass printing, four pieces of partial image data are printed simultaneously.

In step S1510, the printer 100 determines whether or not the printing of the input image data is complete.

In the case where the printing is not complete (“NO” in step S1510), the paper feed mechanism 111 advances the print medium by a predetermined length in step S1511, and in step S1512, the printer 100 increments the value of i by 1, after which the process returns to step S1503.

However, in the case where the printing is complete (“YES” in step S1510), the processing ends.

In this manner, in the present embodiment, it is possible to perform multi-pass printing while ensuring the independence and dispersity of dots among pieces of pass print data.

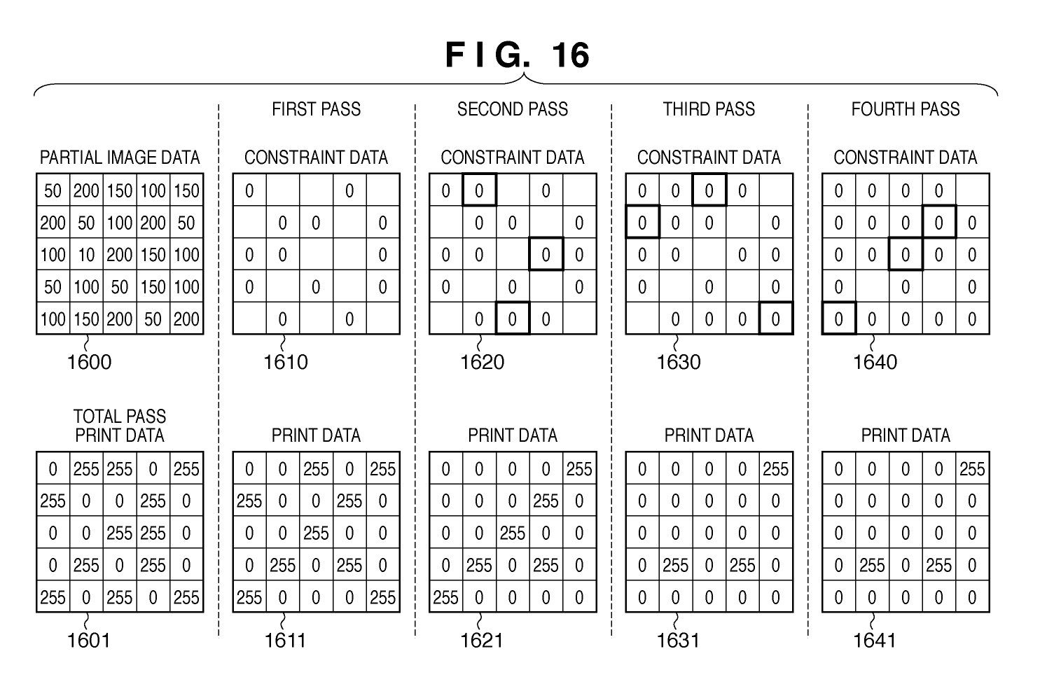

Although in the present embodiment, the print duties in the error diffusion for each pass are all set to 25%, it should be noted that the number of dots discharged can be unified among the passes using other settings as well. Such other settings shall be described using FIG. 16. FIG. 16 is a diagram illustrating an example of the progress of the constraints given to each pass and the print data.

In the same manner as described with reference to FIG. 8, partial image data 1600 is converted into total pass print data 1601, and first pass constraint data 1610 is created.

Next, with the first pass constraint data 1610 used as a constraint, the print duty is set to 75%, and a binary conversion process is carried out. As a result, the partial image data 1600 is converted into first pass print data 1611. After this, pixels with a pixel value of 255 in the total pass print data 1601 but with a pixel value of 0 in the first pass print data 1611 are printed in the first pass. This makes it possible to print 25% of the dots in the total pass print data in the first pass. Furthermore, a constraint that sets the constraint value of the pixels printed in the first pass to 0 is added to the first pass constraint data 1610, creating second pass constraint data 1620.

Next, with the second pass constraint data 1620 used as a constraint, the print duty is set to 50%, and a binary conversion process is carried out. As a result, the partial image data 1600 is converted into second pass print data 1621. Then, pixels with a pixel value of 255 in the first pass print data 1611 but with a pixel value of 0 in the second pass print data 1621 are printed in the second pass. This makes it possible to print 25% of the dots in the total pass print data in the second pass. Furthermore, a constraint that sets the constraint value of the pixels printed in the second pass to 0 is added to the second pass constraint data 1620, creating third pass constraint data 1630.

In the same manner, the print duty is set to 25% and third pass print data 1631 is created, and the difference between the second pass print data 1621 and the third pass print data 1631 is printed.

Finally, in the fourth pass, pixels for which a constraint value is not set in fourth pass constraint data 1640 are printed as fourth pass print data 1641.

Through the above process, the total pass print data 1601 can be divided into four passes with equal amounts of dots and printed.

### Second Embodiment

In the first embodiment, the printer 100 stored constraint data for performing error diffusion in the constraint buffer 920. However, because it is necessary for the constraint buffer 920 to have a region sufficient for the number of nozzles in the head 110× the printing width of the printer 100, the RAM 103 will be strained if the number of nozzles, printing width, and so on increase. Accordingly, the present embodiment shall describe a method of performing multi-pass printing using error diffusion method, without utilizing the constraint buffer 920.

The constraint data used in the error diffusion for each pass, the print data that is printed, and so on in the present embodiment are the same as the example illustrated in FIG. 8. However, because the constraint data is not stored in the constraint buffer 920, all the necessary error diffusion for the passes printed in a single scan is performed each time.

For example, consider a case where the second pass print data 821 of the partial image data 800 is printed in a certain scan. In the present embodiment, it is not possible to acquire constraint values from the second pass constraint data 820 stored in the constraint buffer 920. Pixels in the second pass constraint data 820 with a constraint value of 0 have a pixel value of 0 in the total pass print data 801, and thus are pixels that have a pixel value of 255 in the first pass print data 811. Accordingly, when performing error diffusion for converting the data to the second pass print data 821, the error diffusion for calculating the total pass print data 801 and the error diffusion for calculating the first pass print data 811 are performed simultaneously, and the outputs thereof are used in the error diffusion for calculating the second pass print data 821.

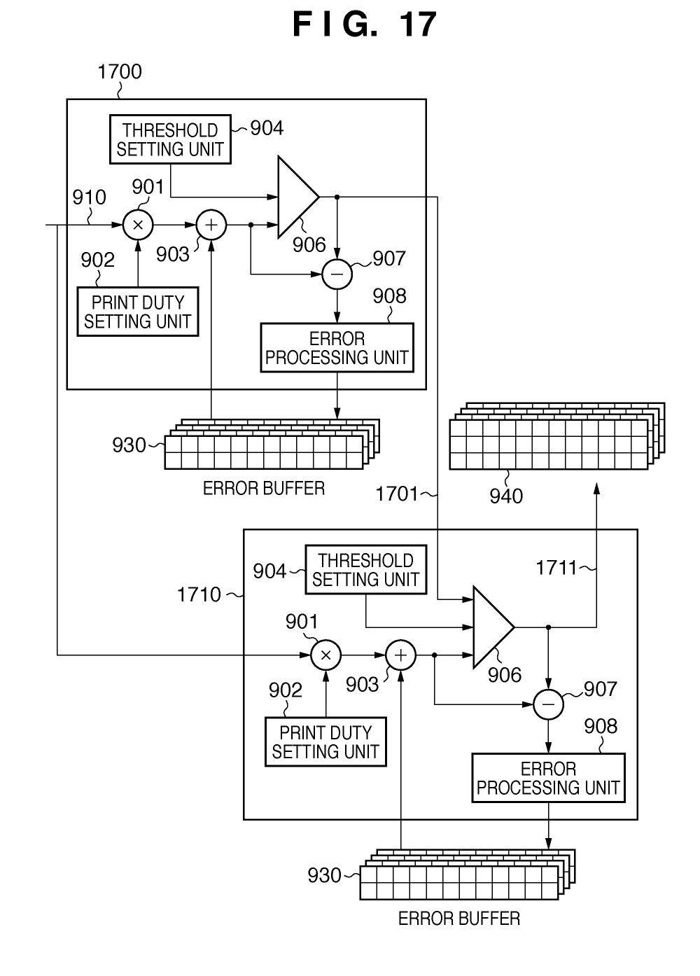

The binary conversion processing unit 106 according to the present embodiment shall be described using FIG. 17. FIG. 17 is a block diagram illustrating an example of the configuration of the binary conversion processing unit 106, which does not use a constraint buffer. Elements that perform the same operations as those of the binary conversion processing unit 900 shown in FIG. 9 shall be given the same reference numerals, and descriptions thereof shall be omitted.

The binary conversion processing unit 106 shown in FIG. 1 is configured of multiple binary conversion processing units. Each binary conversion processing unit performs a single error diffusion. For example, a first binary conversion processing unit 1700 shown in FIG. 17 performs an error diffusion for converting the partial image data 800 into the total pass print data 801. Meanwhile, a second binary conversion processing unit 1710 performs an error diffusion for converting the partial image data 800 into the first pass print data 811. Because the input image data is common for both error diffusions, the pixel values 910 of the input image data are inputted into all the binary conversion processing units. Each binary conversion processing unit performs operations similar to those described in the first embodiment. However, the second binary conversion processing unit 1710 uses output values 1701 from the first binary conversion processing unit 1700, rather than acquiring constraint data from a constraint buffer. Output values 1711 from the second binary conversion processing unit 1710 are the pixel values of the first pass print data 811.

Similarly, three binary conversion processing units are necessary in the case where the second pass print data 821 is output. A number of binary conversion processing units equivalent to the number of necessary error diffusions is necessary for other pass print data as well.

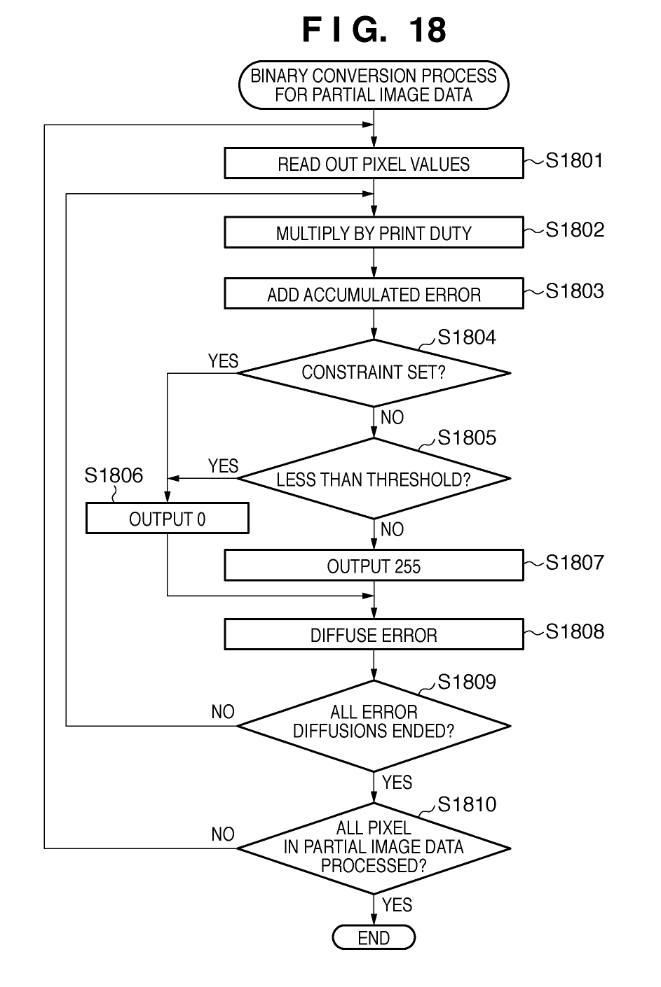

Next, operations performed by the binary conversion processing unit 106 according to the present embodiment shall be described using FIG. 18. FIG. 18 is a flowchart illustrating an example of operations performed by the binary conversion processing unit 106. Processing based on this flowchart is performed by the CPU 101 processing a computer program written into the ROM 102. This process may be partially carried out by hardware.

In step S1801, the printer 100 reads out the pixel values 910 of the partial image data, and inputs those values to the multipliers 901 provided in all the binary conversion processing units. Next, the processes of steps S1802 to S1808 are executed by the first binary conversion processing unit 1700, thereby performing a first error diffusion.

In step S1802, the multiplier 901 multiplies the print duty set by the print duty setting unit 902 by the pixel values 910 of the partial image data, and outputs the resultant to the adder 903. The print duty setting unit 902 sets the print duty to 100% in the case where the input image data is converted to total pass print data, and sets the print duty to 25% in the case where the input image data is converted to partial print data for each pass.

In step S1803, the adder 903 adds the accumulated error of the pixel of interest read out from the error buffer 930 to the input from the multiplier 901, and outputs the resultant to the binary data output unit 906.

In step S1804, the binary conversion processing unit determines whether or not a constraint value is specified for the pixel of interest based on the output values from the binary data output units 906 included in the other binary conversion processing units. The first binary conversion processing unit 1700 does not receive the outputs from the binary data output units 906 included in the other binary conversion processing units. The reason for this is that no constraint is set in the error diffusion for calculating the total pass print data.

In the case where a constraint is specified (“YES” in step S1804), the process moves to step S1806, where the binary data output unit 906 outputs 0 in accordance with the constraint.

However, in the case where a constraint is not specified (“NO” in step S1804), the process moves to step S1805.

In step S1805, the binary data output unit 906 compares the value of the input from the adder 903 with the threshold set by the threshold setting unit 904. The threshold setting unit 904 sets the threshold based on the print duty. For example, in the case where the print duty is 100%, the threshold is set to 128, whereas in the case where the print duty is 25%, the threshold is set to 32.

In the case where the input from the adder 903 is the lesser of the two (“YES” in step S1805), the process moves to step S1806. In step S1806, the binary data output unit 906 outputs 0.

However, in the case where the input from the adder 903 is not the lesser of the two (“NO” in step S1805), the process moves to step S1807. In step S1807, the binary data output unit 906 outputs 255. The output values are input to other binary conversion processing units, or are input to the print buffer 940.

In step S1808, the subtractor 907 calculates the error arising in the pixel of interest, and inputs the resultant to the error processing unit 908. Based on the input error, the error processing unit 908 updates the accumulated error in the peripheral pixels of the pixel of interest based on the equations (4) to (12).

In step S1809, the binary conversion processing unit 106 determines whether or not all error diffusions have ended. For example, in the case of calculating the total pass print data, a single error diffusion may be performed, whereas in the case of calculating the second pass print data, it is necessary to perform three error diffusions.

In the case where the all the error diffusions have ended (“YES” in step S1809), the process moves to step S1810. However, in the case where there is an error diffusion that has not ended (“NO” in step S1809), the process is repeated by the next binary conversion processing unit from step S1802 in order to perform the next error diffusion.

In step S1810, the binary conversion processing unit 106 determines whether or not the binary conversion process has been completed for all pixels in the partial image data. In the case where the process has not been completed (“NO” in step S1810), the process returns to step S1801, and the next pixel is processed. However, in the case where the process has been completed (“YES” in step S1810), the binary conversion process of the partial image data ends.

The multi-pass printing of the input image data is the same as illustrated in the flowchart in FIG. 15 and described in the first embodiment, and thus descriptions thereof shall be omitted here.

In this manner, in the present embodiment, it is possible to perform multi-pass printing while ensuring the independence and dispersity of dots among pieces of pass print data, while also suppressing the amount of data stored in the RAM 103. The error buffer 930 is also necessary in the present embodiment. However, as described using FIG. 13, the error buffer 930 is smaller in size than the constraint buffer 920, and thus it has little influence.

Like the first embodiment, it should be noted that it is possible to unify the number of dots discharged in the passes even when using settings aside from those that set the print duty to 25% in each pass in the present embodiment as well.

### Third Embodiment

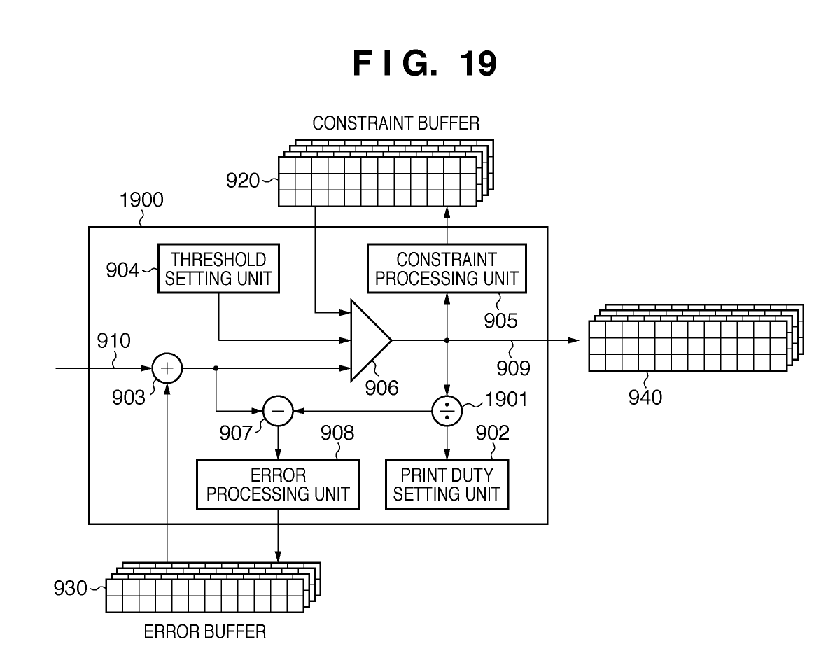

The present embodiment describes a different configuration of the binary conversion processing unit 106. With the binary conversion processing unit 900 shown in FIG. 9, the input image data is multiplied by the print duty. Because the print duty is a numerical value of 1 or less, a rounding error arises when the unit is implemented using a circuit. In order to prevent this rounding error, a binary conversion processing unit 1900, shown in FIG. 19, uses a divider 1901 instead of the multiplier 901. FIG. 19 is a block diagram illustrating an example of the configuration of the binary conversion processing unit 1900.

In FIG. 19, elements that have the same functions as those of the binary conversion processing unit 900 shown in FIG. 9 are given the same reference numerals, and descriptions thereof shall be omitted. The divider 1901 divides the output from the binary data output unit 906 by the print duty, and inputs the resultant to the subtractor 907. Because the print duty is 1 or less, the divider 1901 essentially multiplies by the inverse of the print duty. This is equivalent to bit shifting the value input into the divider 1901 to the left. For example, in the case where the print duty is 25%, a two-bit shift is performed. As a result, it is possible to reduce the influence of rounding error beyond what is possible with the binary conversion processing unit 900, which multiplies the input image data by the decimal point set in the print duty setting unit 902.

Conversion to print data in accordance with the set print duty is also possible with the binary conversion processing unit 1900. In the case where the output from the binary data output unit 906 is 0, the value of the error E does not change, regardless of the value of the print duty. However, in the case where the output is 255, the value of the error E increases the lower the value of the print duty is. Because the value of the error E is negative when the output is 255, the lower the value of the print duty is, the lower the pixel values of the peripheral pixels in which the accumulated error has been applied are. For this reason, the lower the value of the print duty is, the fewer the number of pixels with pixel values of 255 are in the print data as a whole.

### Other Embodiments

The above-described exemplary embodiments of the present invention can also be achieved by providing a computer-readable storage medium that stores program code of software (computer program) which realizes the operations of the above-described exemplary embodiments, to a system or an apparatus. Further, the above-described exemplary embodiments can be achieved by program code (computer program) stored in a storage medium read and executed by a computer (CPU or micro-processing unit (MPU)) of a system or an apparatus.

The computer program realizes each step included in the flowcharts of the above-mentioned exemplary embodiments. Namely, the computer program is a program that corresponds to each processing unit of each step included in the flowcharts for causing a computer to function. In this case, the computer program itself read from a computer-readable storage medium realizes the operations of the above-described exemplary embodiments, and the storage medium storing the computer program constitutes the present invention.

Further, the storage medium which provides the computer program can be, for example, a floppy disk, a hard disk, a magnetic storage medium such as a magnetic tape, an optical/magneto-optical storage medium such as a magneto-optical disk (MO), a compact disc (CD), a digital versatile disc (DVD), a CD read-only memory (CD-ROM), a CD recordable (CD-R), a nonvolatile semiconductor memory, a ROM and so on.

Further, an OS or the like working on a computer can also perform a part or the whole of processes according to instructions of the computer program and realize functions of the above-described exemplary embodiments.

In the above-described exemplary embodiments, the CPU jointly executes each step in the flowchart with a memory, hard disk, a display device and so on. However, the present invention is not limited to the above configuration, and a dedicated electronic circuit can perform a part or the whole of processes in each step described in each flowchart in place of the CPU.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2008-116292, filed Apr. 25, 2008 which is hereby incorporated by reference herein in its entirety.

What is claimed is:

1. An image forming apparatus that converts image data into print data that contains print pixels and non-print pixels, divides the print data into a plurality of passes, and prints the print data, the apparatus comprising:
a conversion unit configured to generate first print data and a plurality of pieces of second print data by converting the image data using an error diffusion method; and
a printing unit configured to print the plurality of pieces of second print data,
wherein the conversion unit:
performs a first conversion that converts the image data into the first print data using the error diffusion method;
generates constraint data specifying the non-print pixels in the first print data as non-print pixels in the second print data; and
performs a second conversion that converts the image data into the plurality of pieces of second print data, each piece of second print data being used in one of the plurality of passes, through an error diffusion method that uses the constraint data, and
the printing unit forms an image expressing the image data by printing, in each of the plurality of passes, the piece of second print data that corresponds to said pass.

2. The apparatus according to claim 1,
wherein the conversion unit generates the piece of second print data that is used in the most preceding pass in the plurality of pieces of second print data, by converting the image data by performing the error diffusion method that uses the constraint data; and
generates the second print data used in a pass subsequent to the most preceding pass by converting the image data by performing an error diffusion method that uses constraint data further specifying the print pixels in all passes prior to the subsequent pass as non-print pixels.

3. The apparatus according to claim 2, wherein the conversion unit takes print pixels in the second print data that is used in the last pass as pixels that are print pixels in the first print data but are non-print pixels in any of the passes previous to said last pass.

4. The apparatus according to claim 1, wherein the second conversion converts image data obtained by multiplying the pixel values of the image data by a predetermined constant.

5. The apparatus according to claim 1, wherein the second conversion uses the difference between values obtained by dividing the post-conversion pixel values by a predetermined constant and the pre-conversion pixel values as the error in the error diffusion method.

6. The apparatus according to claim 4, wherein the predetermined constant is the inverse of the number of passes.

7. The apparatus according to claim 1, further comprising a storage unit configured to store the constraint data,
wherein the second conversion uses the constraint data stored in the storage unit.

8. The apparatus according to claim 1, wherein the conversion unit generates the constraint data used in the second conversion each time a second conversion is performed.

9. A control method for an image forming apparatus that converts image data into print data that contains print pixels and non-print pixels, divides the print data into a plurality of passes, and prints the print data, the method comprising:
generating first print data and a plurality of pieces of second print data by converting the image data using an error diffusion method; and
printing the plurality of pieces of second print data,
wherein at the generating:
performing a first conversion that converts the image data into the first print data using the error diffusion method;
generating constraint data specifying the non-print pixels in the first print data as non-print pixels in the second print data;
performing a second conversion that converts the image data into the plurality of pieces of second print data, each piece of second print data being used in one of the plurality of passes, through an error diffusion method that uses the constraint data, and
at the printing, forming an image expressing the image data by printing, in each of the plurality of passes, the piece of second print data that corresponds to said pass.

10. A storage medium storing a computer program causing a computer to function as the apparatus according to claim 1.
